(19) United States
(12) Patent Application Publication
(10) Pub. No.: US 2025/0315400 A1
(43) Pub. Date: Oct. 9, 2025

(54) CONNECTOR HUB SYSTEM, CONTROL METHOD AND CONTROL PROGRAM PRODUCT

(71) Applicant: WOTA CORP., Tokyo (JP)

(72) Inventors: Kageto IMAHASHI, Kanagawa (JP); Isao ISHIDA, Kanagawa (JP)

(73) Assignee: WOTA CORP., Tokyo (JP)

(21) Appl. No.: 18/583,844

(22) PCT Filed: Aug. 20, 2022
(86) PCT No.: PCT/JP2022/031470

§ 371 Date: Jun. 18, 2025

(30) Foreign Application Priority Data
Aug. 23, 2021 (JP) 2021-135963

(51) Int. Cl. G06F 13/40

(52) U.S. Cl. CPC G06F 13/409; G06F 2213/40

(57) ABSTRACT

The present invention solves the problems of program complexity and reduced processing speed. The present invention is a connector hub system provided with: a sensing device for detecting physical and chemical quantities, a change amount, and/or a condition, of a monitored target; a hub connected to the sensing device and having terminals to input detected data from the sensing device; a controller mounted in the hub and containing a processor and a storage; and a data memory in the storage for storing the detected data collected from the sensing device. The connector hub system comprises includes a monitoring device communicatively connected to the data memory in the hub for monitoring the detected data from the sensing device, and the monitoring device is connected in series to the plurality of hubs and monitors a nearest hub closest to the monitoring device for observing all of the detected data input to the plurality of hubs.

### TECHNICAL FIELD

The present invention relates to a connector hub system used to monitor detected data acquired from a sensor, and a control method and a control program using the detected data.

### BACKGROUND ART

A configuration of a control system (single board type) for example shown in FIG. 11 is known in case of controlling an operation of a device or the like based on electrical signals output from a sensor as physical and chemical quantities of a monitored target. FIG. 11 shows a sensor probe 114, a dedicated board 99 electrically connected to the probe 114, and a controller 112 electrically connected to the dedicated board 99 to control the operation of a controllable drive device (not shown) according to a drive program based on signals from the dedicated board 99.

In the control system shown in FIG. 11, the dedicated board 99 is required for the specific probe 114. That is, since none other than the specific probe 114 can be connected to the dedicated board 99 (no universality), when using a plurality of various sensors, the controller 112 has to be connected to a plurality of pairs of the probe 114a-114d and corresponding dedicated board 99a-99d as shown in FIG. 12. However, such a control system of multi (parallel) lines multi boards type (4 lines in FIG. 12) complicates the drive program and control, and loads on the single controller 112 to thereby reduce the capacity and speed for processing. Further, if the single control system (FIG. 11) is enlarged to more than two lines for a purpose of increasing a number of the probes 114, it is necessary to change the drive program for the controller 112.

FIG. 13 shows an idea of another control system (one line multi boards type) that the dedicated boards 99a-99d are connected in series and respectively connected to probes 114a-114d for the purpose of increasing a number of probes while avoiding more than two lines of the control system. However, the dedicated board 99a-99d is designed so as to connect only the specific probe 114a-114d, so that it would be actually impossible to connect the dedicated boards 99a-99d in series to each other as shown in FIG. 13 (no expandability and no super-universality). Namely, the idea of FIG. 13 would be practically impossible. Even if the system in FIG. 13 is realized, when a trouble 131 or a maintenance arises on a part of the dedicated boards 99a-99d or a transmission line, the controller 112 cannot transmit signals to or receive them from at least the dedicated boards 99c,99d which are located distant from the trouble 131 position, due to an interruption of the series transmission line. In addition, it would be easy to collectively extract information by hacking from the one line of dedicated boards 99a-99d.

Patent Document 1 discloses a sensor device comprising a control board having a microcontroller, a dedicated board for sensor with a sensor element, and a relay board between the control and dedicated boards. FIG. 14 according to a concept of Patent Document 1 shows a control system (single hub and multi lines multi boards type) comprising a hub 101 as a relay device with terminals 111 that physically and electrically can connect each of the dedicated boards 99a-99d to increase or decrease a number of probes 114a-114d under a predetermined range as necessary. However, the terminals 111 of the hub 101 in FIG. 14 fail to connect more than the predetermined number (4 channels in FIG. 14) of the dedicated boards 99a-99d. Further, a type of the terminal 111 is fixed as analog or digital and input or output so that it cannot change the type as necessary.

### CITATION LIST

### Patent Literature

Patent Document 1: WO2017/149625

### SUMMARY OF INVENTION

### Technical Problem

Therefore, an object of the present invention is to provide a connector hub system, a control method and a control program that solve the aforementioned problems of the prior arts. That is, the present invention provides the connector hub system, the control method and the control program that are possible to increase or decrease a number of sensor probes as necessary while avoiding the complicated multi (parallel) lines control. It provides the connector hub system, the control method, and the control program which have no need of the dedicated board and are possible to maintain a normal operation even if the operation of series hubs stops at a part thereof.

### Solution to Problem

A connector hub system of the present invention comprises: a sensing device 14,24 for detecting a physical quantity, a chemical quantity, a change amount, and/or a condition, of a monitored target; a hub 1,2 connected to the sensing device 14,24 and having terminals to input detected data from the sensing device 14,24; and a controller 15 mounted in the hub 1,2 and containing a processor 16 and a storage 18. The hub 1,2 comprises: a data memory 81 in the storage 18 for storing the detected data collected from the sensing device 14,24; and a connector 22 configured on the hub 1,2 so as to detachably connect between the hub 1,2 and another hub 3-10. In the connector hub system, the data memory 81 in the hub 1,2 is communicatively connected to a monitoring device 13 for monitoring the detected data from the sensing device 14,24, and the monitoring device 13 is connected in series to the plurality of hubs 1,2 and monitors a nearest hub 1 closest to the monitoring device 13 for observing all of the detected data input to the plurality of hubs 1,2. The connector hub system of the present invention comprises the connector 22 that is additionally and detachably possible to connect the hub 1,2 to another hub 3-10 in case of lacking in the probe or the terminal or to increase a number of data detections. This allows to freely adjust increasing or decreasing the number of the sensor probes 14 connected to the terminals 11 as necessary. Further, when the hub 1,2 connects the additional hub(s) 3-10 via the connector 22, the data memory 81 in the hub 1 can store or memorize the detected data obtained from not only the hub 1 but also the additional hub(s) 3-10.

In the present invention, the monitoring device 13 is connected in series to the plurality of hubs 1,2 and can monitor all of the detected data obtained from one or more hubs 1,2 on the one line by monitoring only the nearest hub 1 to thereby overcome the conventional problems of the program complexity and the reduced processing speed due to the multi lines (parallel) system. Further, each of the hubs 1,2 connected in series to the monitoring device 13 is provided with the storage 18 that can store data in any of the hubs 1,2 to enable a reliable backup of the data even if a trouble or disconnection occurs at a part of hubs 1,2.

A control method for a connector hub system, comprising steps of: assigning a terminal type to each of terminals 11 in a hub 1,2, the terminal type being any of a digital input, an analog input, a digital output, or an analog output; detecting by a plurality of sensing devices, a physical quantity, a chemical quantity, a change amount, and/or a condition, of a monitored target; inputting detected data from the plurality of sensing devices 14,24 through the terminals 11 assigned with the terminal types; converting by an AD conversion unit 62, the detected data from an analog signal into a digital signal, the AD conversion unit 62 inputting the detected data as the analog signal through the terminals 11 of the hub 1,2; receiving by a digital receiving unit 63, the detected data as the digital signal from the AD conversion unit 62 and from the plurality of sensing devices 14,24 through the terminals 11 of the hub 1,2; storing by a storing unit 65, the detected data from the digital receiving unit 63 into an individual data memory 81a of a storage 18; comparing by a comparison unit 67, between a numerical value of the detected data from the digital receiving unit 63 or from the individual data memory 81a and a threshold value stored in a threshold database 82 of the storage 18; and based on a result obtained by the comparison unit 68, outputting by a drive command unit 68, a drive signal to controllable drive devices 21 connected to the terminals 11 of the hub 1,2; wherein the connector hub system comprises a monitoring device 13 connected in series to a plurality of hubs 1,2, and the monitoring device 13 monitors a nearest hub 1 closest to the monitoring device 13 for observing all of the detected data input to the plurality of hubs 1,2. The control method of the present invention comprises a step of assigning to each of terminals, any terminal type of digital or analog input or digital or analog output, and therefore, the terminal type can be flexibly selected with no need of the dedicated board which was necessary for the fixed terminal (which failed to select and change the terminal type).

A control program of the present invention is the program for causing a computer to execute the control method. Based on detected data obtained from sensing devices 14,24, controllable drive devices 21a-21c can be reliably driven and controlled for performing efficient operations thereof.

### Advantageous Effect of Invention

The connector hub system, control method and control program of the present invention can appropriately increase and decrease the number of the sensor probes and the controllable drive devices and require no dedicated board for the specific sensor, so that the present invention can provide the connector hub system excellent in the versatility and the additional expandability. Further, the system, method and program monitor only the leading hub nearest the monitoring device to reduce the monitoring and processing loads and to safely and reliably control the controllable drive device without any erroneous operation. Furthermore, the data can be transferred as appropriate within the connector hub system, and therefore, it is effective for measures against hacking and terrorism.

### BRIEF DESCRIPTION OF DRAWINGS

FIG. 1 is a block diagram showing a connector hub system (first embodiment);

FIG. 2 is a block diagram showing a configuration of a controller;

FIG. 3 is a block diagram showing a connector hub system (second embodiment) according to the present invention;

FIG. 4 is a block diagram showing a connector hub system (third embodiment) according to the present invention;

FIG. 5 is a block diagram showing a connector hub system (fourth embodiment) according to the present invention;

FIG. 6 is a block diagram showing a connector hub system (fifth embodiment) according to the present invention;

FIG. 7 is a block diagram showing a connector hub system (sixth embodiment) according to the present invention;

FIG. 8 is a block diagram showing a connector hub system (seventh embodiment) according to the present invention;

FIG. 9 is a block diagram showing a connector hub system (eighth embodiment) according to the present invention;

FIG. 10 is a block diagram showing an embodiment for calibrating a sensor using a connector hub system according to the present invention;

FIG. 11 is a block diagram showing a conventional control system (single board type);

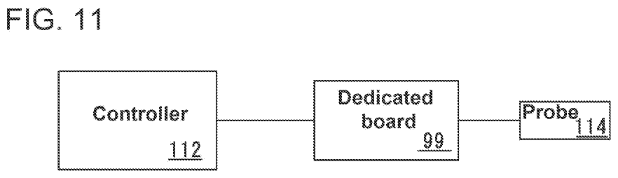

FIG. 12 is a block diagram showing a conventional control system (multi lines multi boards type);

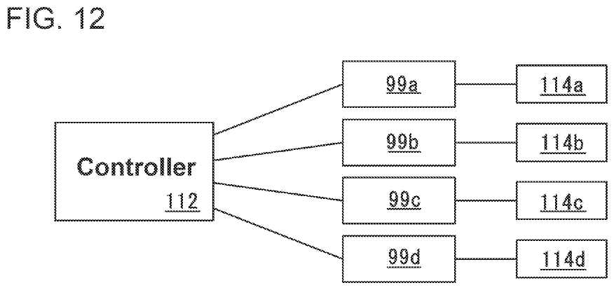

FIG. 13 is a block diagram showing a conventional control system (one line multi boards type); and

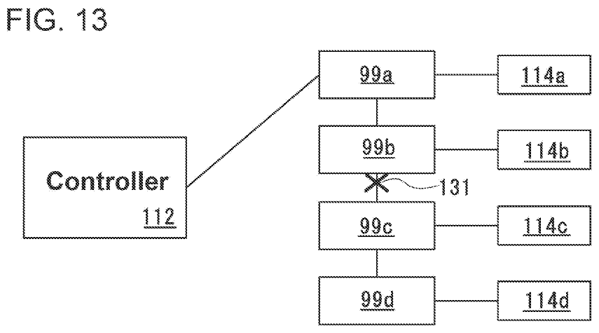

FIG. 14 is a block diagram showing a conventional control system (single hub and multi lines multi boards type).

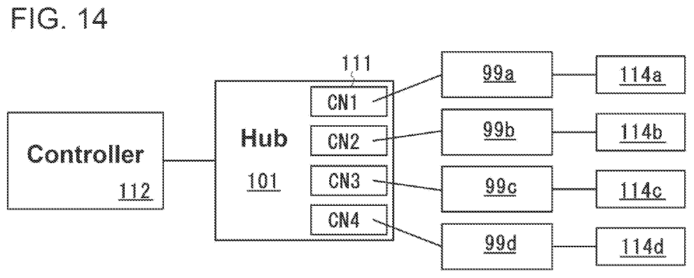

### DESCRIPTION OF EMBODIMENTS

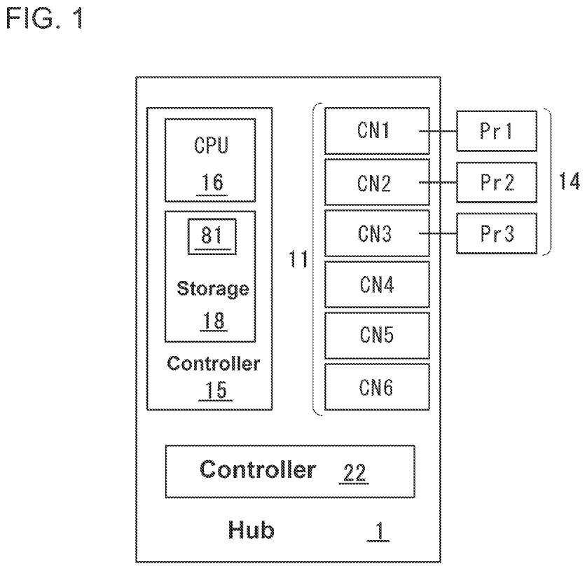

Embodiments according to the present invention will be described with reference to FIGS. 1 to 10. The following embodiments are for illustrative purposes, but should not be interpreted as limiting the present invention.

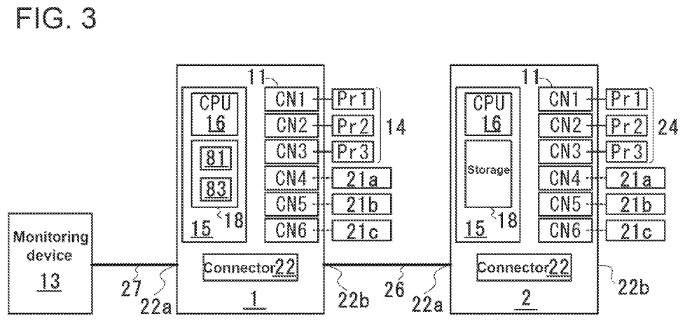

FIG. 1 shows a connector hub system (first embodiment) applied to embodiments in FIG. 3 and thereafter. The system comprises: a plurality of sensing devices 14 for detecting a physical quantity, a chemical quantity, a change amount, and/or a condition of a monitored target; and a hub 1 with a plurality of terminals 11 connected to the sensing device 14 so as to input detected data from the sensing device 14.

The sensing devices 14 and 24 shown in FIG. 3 and thereafter are sensors or measuring instruments, and output the detected data including one or more selected from: environmental information such as light, temperature, humidity, air pressure, position, distance, horizontal or the like; gas information such as odor, concentration toxicity or the like; liquid information such as water hardness, water viscosity, hydrogen ion concentration (pH), nitrogen amount, ammonia, residual chlorine, salt, conductivity, chromaticity, turbidity, chemical substance, radioactivity; mass information such as water level, pressure, liquid volume, gas residue, powder residue, flow rate, weight or the like; material information such as material hardness, material characteristics (discrimination of wood, metal, glass, etc.) or the like; velocity information such as flow velocity, speed, time or the like; electric energy information such as power consumption, voltage amount or the like; operating information such as opening and closing solenoid valve, lamp indicating operating condition, button switch, pump or the like. The sensing device 14 also includes such as a sensor probe, an electronic element, a camera, a microphone, or the like, that output physical or chemical phenomena as electrical signals. The physical quantity of the monitored target, for example, force, light, electromagnetic waves, temperature, sound, velocity, acceleration, or the like, and the chemical quantity of the monitored target includes, for example, pH, concentration, consistency, toxicity, or the like.

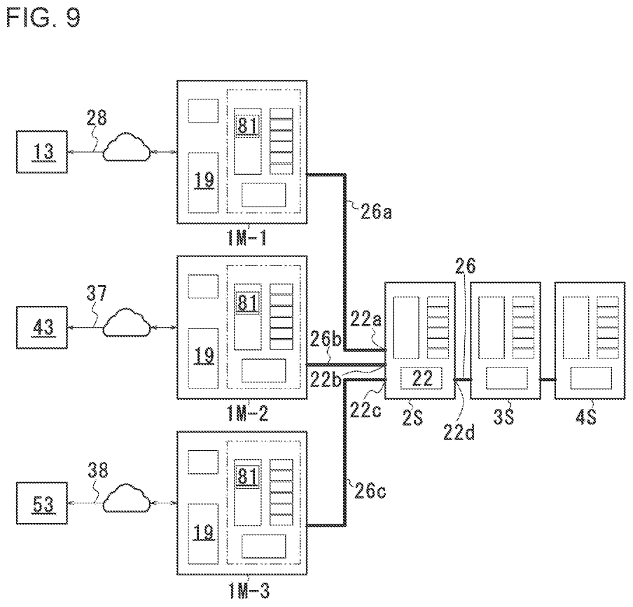

In the embodiment of FIG. 1, one hub 1 is provided with six terminals (CN1-CN6) 11 comprising the terminals CN1-CN3 as input terminals connected to the sensor probes Pr1-Pr3. It has no limitation of the number and size of the terminals 11 and the number and type of the connected sensor probes Pr1-Pr3. The terminal 11 can be selected and changed as any of the digital or analog input terminal or the digital or analog output terminal, and the terminal 11 is referred to as a virtual terminal, a virtual input/output terminal, or a variable terminal. The hub 1 is equipped with a controller 15 which comprises a storage 18 including a volatile memory (RAM) and a non-volatile memory (ROM). The storage 18 of the hub 1 contains a data memory 81 to store the detected data acquired from the sensing device 14 of the hub 1. The data memory 81 can store all the past and present detected data within the capacity range. The detected data stored in the data memory 81 may be monitored from an outside of the hub 1 via a processor (central processing unit, CPU) 16 and via a data bus not shown. The controller 15 may be operated by an operating system (OS). The hub 1 in FIG. 1 further comprises a connector 22 for detachably connecting the hub 1 to another hub 2-10. In the block diagram of FIG. 1, although the connector 22 is schematically shown by one block, it may be composed of more than two ports (illustrated in FIGS. 3 and 9) or an interface. The connector 22 capable of transmitting and receiving data is not limited, and is preferably the connector of universal serial bus (USB) or local area network (LAN), or the interface of Wi-Fi or Bluetooth, having the versatility. The multiple connected hubs can operate without any failure, by unifying a standard between the hub 1 and other hubs 2-10, such as, unifying an operating system used between the controllers 15 in the hubs.

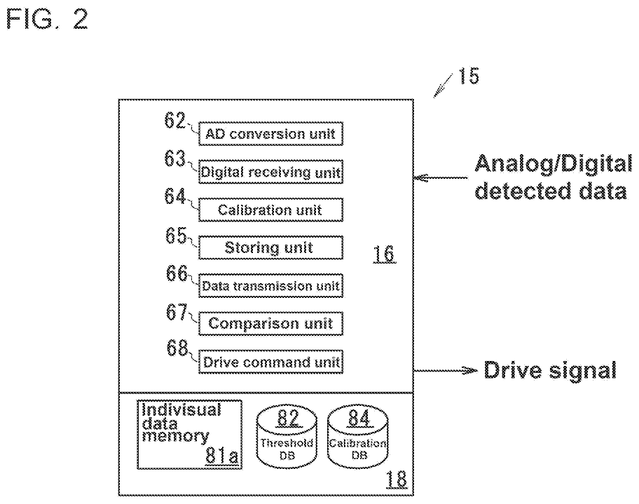

FIG. 2 is a block diagram schematically illustrating an inner structure of the controller 15 applied to embodiments in FIG. 3 and thereafter. The processor 16 in the controller 15 comprises: an AD conversion unit 62 to convert the detected data from an analog signal into a digital signal, the analog signal being input from the sensing device 14 through the terminal 11 of the hub 1,2; and a digital receiving unit 63 to receive the detected data as the digital signal input through the terminal 11 of the hub 1 and converted from the analog signal by the AD conversion unit 62. The AD conversion unit 62 and the digital receiving unit 63 generate input signals necessary for the controller 15 so that the dedicated board for sensor is not required in the present invention. The processor 16 comprises a storing unit 65 to store the detected data from the digital receiving unit 63 into an individual data memory 81a in the storage 18 through or without a calibration unit 64 described below. Optionally, a data transmission unit 66 can be provided to transmit to an outside of the hub 1, the detected data received in the digital receiving unit 63 or stored in the individual data memory 81a. The AD conversion unit 62 is an analog-to-digital (AD) converter for sampling, quantizing and encoding the analog signals and converts them into the digital signals, and includes the AD converter of for example, a flash type, a successive approximation type, a pipeline type, a delta-sigma type, a double integral type. The individual data memory 81a may be a part of the data memory (whole data memory) 81 shown in FIG. 1 or may be independent of the data memory 81. The individual data memory 81a stores the detected data obtained only from the hub 1.

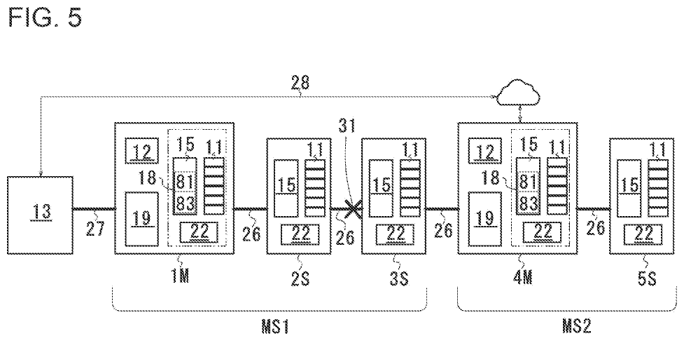

The controller 15 of FIG. 2 further can comprise: a comparison unit 67 to compare between a numerical value of the detected data received in the digital receiving unit 63 or stored in the individual data memory 81a and a threshold value stored in a threshold database 82 of the storage 18; and a drive command unit 68, based on a comparison result obtained by the comparison unit 67, to output a drive signal to the controllable drive devices 21a-21c connected to the terminals 11 of the hub 1. The threshold database 82 stores threshold data related to the type and information of the sensing device 14 (For example, if the sensing device 14 is a pH sensor, the upper threshold value is pH8.6 and the lower threshold value is pH5.8). The threshold value can be rewritten remotely by the monitoring device 13, and in the field by a personal computer connectable to the hub and by a programmable logic controller (PLC) 12 (FIG. 5) equipped in the hub, and the like.

FIG. 3 shows a connector hub system (third embodiment) according to the present invention. Descriptions are omitted for the same components as those in FIG. 1. The system comprises a series of plurality of hubs 1,2 with the terminals 11 for inputting the detected data from the sensing devices 14,24, and the hubs 1,2 comprise a nearest hub 1 and an end hub 2 connected to the nearest hub 1. Each of the two serial hubs 1,2 is provided with six terminals (CN1-CN6) 11 that comprise input terminals CN1-CN3 connected to sensor probes Pr1-Pr3 and output terminals CN4-CN6 connected to the controllable drive devices 21a-21c. The controllable drive devices 21a-21c are not limited as to the number and type. The controller 15 of the hubs 1,2 comprises the storage 18, and the processor (central processing unit, CPU) 16 to control the operation of the external controllable drive devices 21a-21c based on the input detected data in accordance with commands of the drive program stored in the storage 18. Since each of hubs 1,2 comprises the storage 18, the detected data can be saved in at least one hub of all the hubs 1,2 and be reliably backed up in the event of a partial failure or disconnection.

As shown in FIG. 3, the monitoring device 13 is connected in series to the plurality of hubs 1,2. The monitoring device 13 contains one or more of a storage, a processor, an input device (keyboard, numeric keypad, mouse, touch panel, button, etc.), an output device (display, speaker, etc.), and is a device or a user interface that can communicate to the hubs 1,2 via wired or wireless, and monitors the drive programs and the plurality of detected data from the sensing devices 14,24. The monitoring device 13 includes a device fixed in a monitoring room, a portable device, and is possible to update, rewrite or change the threshold and program stored in the storage 18 via a communication means. The term “program” includes a drive program, a monitoring program, and a control program for the present invention, and is a general term also including of an algorithm, an operation system program, an application program, and programs other than the drive, monitoring and control programs. Each term of “drive program”, “monitoring program” and “control program” herein also includes each of an algorithm, an operating system program, and an application program. Also, a device other than the monitoring device 13 can update the thresholds and programs in the storage 18. The monitoring device 13 and the device other than the monitoring device 13 are, for example, one or more selected from a personal computer, a mobile device, a smartphone, a mobile phone, a tablet, a programmable logic controller (PLC, programmable controller, sequencer). The monitoring device 13 further includes dedicated device or board equipped with a monitoring program or a dedicated operating system (OS).

The series of two hubs 1,2 in FIG. 3 comprises the nearest hub 1 with one side directly connected to the monitoring device 13 via a transmission line 27 and comprises the end hub 2 connected to the other side of the nearest hub 1 via a transmission line 26. Although FIG. 3 shows the connector hub system comprising only two hubs, one or more hubs may be provided between the nearest hub 1 and the end hub as shown in FIG. 5 and thereafter.

The storage 18 of the nearest hub 1 contains the whole data memory 81 to store the detected data collected from the sensing devices 14,24 of all the hubs. The sensing devices 14,24 of all the hubs comprise not only the sensing device 14 connected to the terminals 11 in the nearest hub 1, but also the sensing device 24 connected to the terminals 11 in the end hub 2 and any sensing devices connected to terminals in a hub not shown between the nearest and end hubs 1,2. The whole data memory 81 can store all the past and present detected data within the capacity range. All the detected data are stored in the whole data memory 81 in the nearest hub 1, and therefore, the monitoring device 13 or a user of the monitoring device 13 can observe all the detected data of the hubs 1,2 by accessing only the nearest hub 1. Namely, in the connector hub system shown in FIG. 3, the monitoring of only the storage 18 in the nearest hub 1 makes it possible to monitor all serial hubs on the one line to avoid the system complexity and the reduced processing speed due to multi lines of the hubs.

The storage 18 in the nearest hub 1 further contains a whole drive memory 83 for storing all the drive programs to control the controllable drive devices 21a-21c connected to the hubs 1,2. The monitoring device 13 can observe the drive programs in all the hubs 1,2 by monitoring only the whole drive memory 83 in the nearest hub 1. Furthermore, the monitoring device 13 observes the detected data and the drive program, and then, can automatically or manually update and change the drive program and threshold value. The connector 22 in the hub 1 of FIG. 3 comprises one port 22a connected to the monitoring device 13 via the transmission line 27 and the other port 22b connected to the hub 2 via the transmission line 26. The connector 22 in the hub 2 of FIG. 3 shows a state that the one port 22a is connected to the hub 1 via the transmission line 26 and the other port 22b is opened, that is, connectable to another hub 3-10. This connector hub system enables to additionally and detachably connect one or more of other hubs 3-10 in series to the connector 22 in the hub 2.

A control method according to the present invention will be described with reference to FIGS. 1 to 3. Since it is similar between operations of the nearest hub 1 and the end hub 2, the control method for the nearest hub 1 is mainly described unless otherwise noted. Firstly, the monitoring device 13 assigns and sets a terminal type (kind of terminal) to each terminal 11 connected to the sensing device 14. The terminal type is any of a digital input, an analog input, a digital output, or an analog output. In this embodiment, the monitoring device 13 assigns and sets for example, the analog inputs to terminals CN1, CN2, the digital input to a terminal CN3, and the digital outputs to terminals CN4-CN6, respectively. Next, the terminals CN1, CN2 are electrically connected to analog probes Pr1, Pr2, and the terminal CN3 is electrically connected to digital probes Pr3, and the terminals CN4-CN6 are electrically connected to digital controllable drive devices (for example, valves) 21a-21c, in order to activate the connector hub system.

In the connector hub system shown in FIGS. 1 and 3, the plurality of sensing devices 14 continuously or intermittently detects physical quantities and the like of the monitored targets and converts into electrical signals. The detected data converted into the electrical signal from the sensing device 14 is input through the plurality of terminals 11 into the hub 1. In this embodiment, the analog signal through the terminals CN1, CN2 and the digital signal through the terminal CN3 are input as the detected data into the hub 1. The detected data of the analog signal input through the terminal CN3 of the hub 1 is converted from analog to digital by an AD conversion unit 62.

The detected data of the digital signal input through the terminal CN3 of the hub 1 is directly received in the digital receiving unit 63, and the detected data of the analog signal input through the terminals CN1, CN2 is digitally converted by the AD conversion unit 62 as described above and is then received in the digital receiving unit 63. Next, the detected data received in the digital receiving unit 63 is stored in the individual data memory 81a of the storage 18 by a storing unit 65, as necessary via a calibration unit 64 described below, with relating the detected data to information such as, sensor type, time, terminal number, usage condition. The detected data received in the digital receiving unit 63 may be stored by a data transmission unit 66 into a storage device other than the individual data memory 81a, for example, the monitoring device 13, a cloud storage 39, a programmable logic controller 12, and/or the storage 18 in another hub. Further, the data transmission unit 66 transmits to the whole data memory 81 in the hub 1, the detected data obtained from the hub 2.

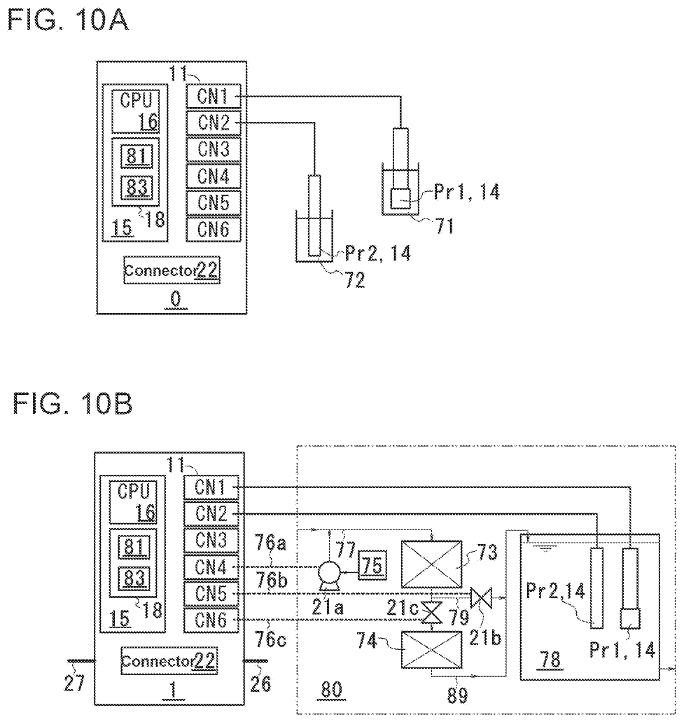

Further, the comparison unit 67 executes comparing between a numerical value of the detected data received in the digital receiving unit 63 or stored in the individual data memory 81a and a threshold value stored in a threshold database 82 of the storage 18. A drive command unit 68 outputs a drive signal based on a comparison result by the comparison unit 67 to the controllable drive device 21a-21c connected to the terminal 11 of the hub 1. The drive signal is output as a digital signal or an analog signal converted by a DA converter, according to a requirement for the controllable drive device 21a-21c. In an example of pH control for liquid in a treated water tank 78 (FIG. 10 (b)), when the numerical value of the detected data is pH 9.0 and the upper threshold stored in the threshold database 82 is pH 8.8, the comparison unit 67 determines that the numerical value of the detected data is higher than the threshold value, and then the drive command unit 68 outputs the drive signal to for example, a pH adjustment pump 21a (FIG. 10 (b)) electrically connected to the terminal CN4, and then the pH adjusting pump 21a is activated to perform an operation for pH reduction (acid injection) of liquid in the treated water tank 78.

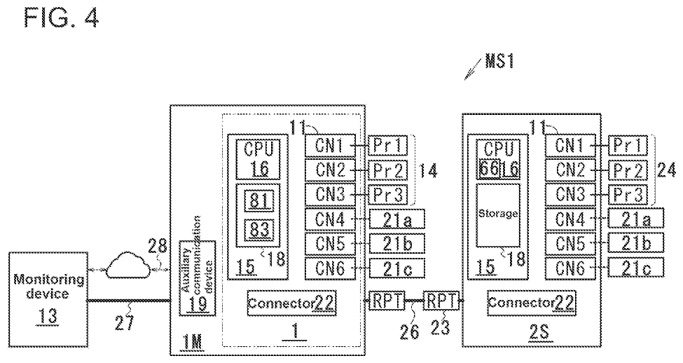

FIG. 4 shows a third embodiment of a connector hub system according to the present invention. Descriptions are omitted for the same components as those in FIGS. 1 and 3. In this connector hub system, the plurality of hubs 1,2 comprising the nearest and end hubs 1,2 comprises: a master hub 1M having an auxiliary communication device 19 capable of wired or wireless communication with the outside; and one or more dependent hubs 2S that are serially subordinate to the master hub 1M; in order to constitute a series of master-dependent system. In FIG. 4, the dependent hub 2S comprises one slave hub 2S without the auxiliary communication device 19, and a series of the master hub 1M and the slave hub 2S forms a master-slave system (hereinafter referred to as “MS system”) MS1. The auxiliary communication device 19 can form a communication means to the monitoring device 13 via a wireless transmission line 28 as a bypass different from the existing transmission line 27 to the monitoring device 13. The auxiliary communication device 19 and the wireless transmission line 28 are provided so as not to necessarily require a short distance between the MS system MS1 and the monitoring device 13.

The processor 16 in the slave hub 2S shown in FIG. 4 comprises a data transmission unit 66 to transmit to at least the master hub 1M, the detected data collected from the plurality of sensing devices 24 connected to the slave hub 2S. Although the data transmission unit 66 sequentially transmits (stream processing) the detected data input through the terminal 11 to the master hub 1M, the data transmission unit 66 may periodically transmit (batch processing) a lump of the detected data accumulated in the individual data memory 81a (FIG. 2) by the storing unit 65 (FIG. 2). Further, in the case of a long distance or the like between the hubs, one or more repeaters (repeater hubs) 23 are provided between the hubs 1M and 2S to amplify and stabilize signals of the detected data from the sensing devices 14,24. The repeater 23 can also be applied to the connector hub systems shown in FIGS. 3 and 5 to 10. Although the embodiment in FIG. 4 shows the MS system MS1, a master-master system (hereinafter referred to as “MM system”) may be configured by comprising the master hub 1M and one or more master hubs successively subordinate to the master hub 1M.

FIG. 5 shows a fourth embodiment of a connector hub system according to the present invention. The system comprises: the monitoring device 13; a first master-dependent system MS1 with one side connected to the monitoring device 13 via a transmission line 27; and a second master-dependent system MS2 connected to the other side of the first master-dependent system MS1. Each of the first and second master-dependent systems MS1, MS2 comprises: the master hub 1M with the auxiliary communication device 19 capable of communicating with the outside; and one or more dependent hubs 2S that are successively subordinate to the master hub 1M. The one or more dependent hubs are one or more master hubs, and/or one or more slave hubs without auxiliary communication device 19, and each of the first and second master-dependent systems can form the MS system or the MM system.

The first MS system MS1 as the first master-dependent system shown in FIG. 5 comprises one master hub 1M and two slave hubs 2S,3S, and the second MS system MS2 as the second master-dependent system comprises one master hub 4M and one slave hub 5S. In the master hubs 1M,4M shown in FIG. 5, the whole data memory 81 and the whole drive memory 83 function to store all of the detected data and the drive programs as in the above embodiments. The programmable logic controller (PLC) 12 in FIG. 5 may be mounted in each master hub 1M,2M to support the controller 15 or the monitoring device 13. The drive programs and other programs can be updated and rewritten in the field by using for example, a user interface (touch panel, etc.) of the PLC.

The control method of the present invention using the connector hub system in FIG. 5 firstly constitutes a plurality of master-dependent (slave) systems MS1, MS2 comprising: the master hub 1M having the auxiliary communication device 19 capable of wired or wireless communication with the outside of the system; and the one and more dependent (slave) hubs 2S successively subordinate to the master hub 1M. Then, the monitoring device 13 is connected in series to at least the proximal first MS system MS1 and the distal second master-dependent system MS2. That is, the first MS system MS1 is directly connected at the opposite side to the monitoring device 13 to the second MS system MS2. Further, the whole data memory 81 and the whole drive memory 83 are provided in the storage 18 of the master connector hub 4M in the second MS system MS2.

In the connector hub system in FIG. 5, if a communication interruption 31 (marked with x in FIG. 5) due to such as an electrical fault or a physical disconnection or the like occurs on the transmission lines 26,27 on the side of the monitoring device 13 from the second master-dependent system MS2, for example, on the transmission line 26 in the first MS system MS1, the distal master hub 4M closest to the interruption 31 position senses that no detected data is transmitted to the master hub 1M via the transmission line 26. If no signal is transmitted after several attempts, the master hub 4M activates a wireless transmission line 28 to the monitoring device 13 via the auxiliary communication device 19. That is, a function for monitoring the whole data memory 81 and the whole drive memory 83 in the nearest hub is switched from the master hub 1M to the master hub 4M of the second MS system MS2. Thereby, the monitoring device 13 monitors the whole data memory 81 and the whole drive memory 83 in the master hub 4M of the second MS system MS2 via the wireless transmission line 28, and is capable of monitoring the detected data and the drive programs of at least the second MS system MS2 and all MS systems located far from the second MS system MS2.

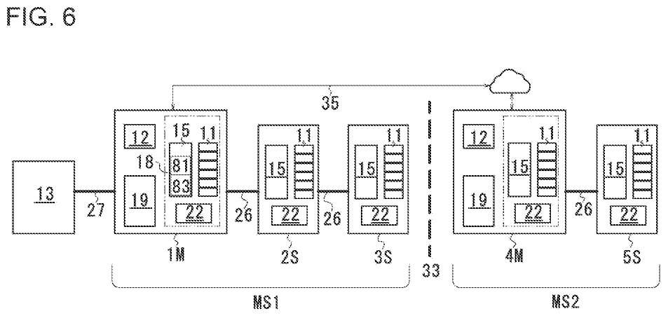

FIG. 6 shows a fifth embodiment of a connector hub system according to the present invention. This system comprises the first and second MS systems MS1, MS2 as two master-dependent systems and includes a situation 33 impossible to connect by wire between the first and second MS systems MS1, MS2. The situation 33 is the case that the first and second MS systems MS1, MS2 fail to connect by wired one another due to the influence of, for example, a long distance, environmental conditions, natural objects, artificial obstacles, or the like. FIG. 6 shows the situation 33 that the second MS system MS2 cannot be wired to the first MS system MS1, alternatively, it may also include other situations that the third and thereafter MS systems not shown cannot be wired to MS systems just before them. In the system in FIG. 6, only the master hub 1M functions as the whole data memory 81 and the whole drive memory 83. Descriptions are omitted for the same components as those in FIG. 5.

The control method of the present invention using the connector hub system in FIG. 6, firstly, forms the plurality of master-dependent systems comprising: a master hub 1M having the auxiliary communication device 19 capable of communicating with the outside; one or more dependent hubs 2S serially dependent from the master hub 1M; and the monitoring device 13 in series connection to the master hub 1M and dependent hubs 2S. In this control method, as shown in FIG. 6, the first and second MS systems MS1, MS2 as the plurality of the master-dependent systems are constituted with one slave hub 2S as the one or more dependent hubs without the auxiliary communication device 19.

If the second MS system MS2 cannot be wired to the first MS system MS1 directly connected to the monitoring device 13 (FIG. 6), a wireless connection is made via a wireless transmission line 35 between the auxiliary communication devices 19 in the first MS system MS1 and in the second MS system MS2 which is nearest to the monitoring device 13 of wired-disconnected MS systems. Secondly, the second MS system MS2 nearest to the monitoring device 13 of the wired-disconnected MS systems transmits the detected data and the drive programs of all of the MS second system MS2 and thereafter to the master hub 1M in the first MS system MS1 (though FIG. 6 does not illustrate the third MS system and thereafter). Further, the whole data memory 81 and the whole drive memory 83 in the master hub 1M of the first MS system MS1 respectively store the detected data and the drive programs transmitted from the second MS system MS2. In the embodiment of FIG. 6, when the situation 33 of the wired-disconnection is resolved, the system ceases the wireless connection via the wireless transmission line 35, and when the situation 33 occurs again, the system can reconnect the wireless transmission line 35.

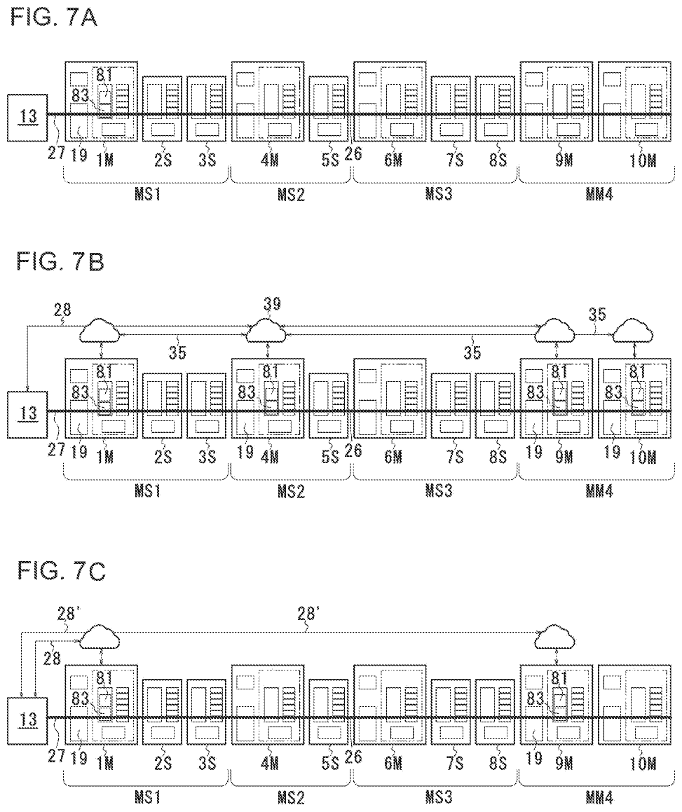

FIG. 7 shows a sixth embodiment of a connector hub system according to the present invention. FIGS. 7 (a) to 7 (c) show a series of first, second and third master-slave (MS) systems MS1-MS3 and a fourth master-master (MM) system MM4 connected in series to the monitoring device 13. That is, they constitute a daisy chain connected like beads. The first MS system MS1 comprises one master hub 1M and two slave hubs 2S,3S, and the second MS system MS2 comprises one master hub 4M and one slave hub 5S, and the third MS system MS3 comprises one master hub 6M and two slave hubs 7S,8S, and the fourth MM system MM4 comprises two master hubs 9M, 10M.

FIG. 7 (a) shows a normal situation that the detected data and the drive programs of all hubs are respectively stored in the whole data memory 81 and the whole drive memory 83 in the master hub 1M via the transmission line 26 and that the monitoring device 13 can monitor all the detected data and the drive programs by accessing only the master hub 1M via the transmission line 27. FIG. 7 (b) shows a connector hub system to back up into one or more of the master hubs 4M, 9M, 10M, all the detected data and the drive programs previously sent from the master hub 1M via the normal transmission line 26 or the wireless transmission line 35 for the case that the detected data would be lost for any reason. In this system, the detected data and the like can be accumulated in not only the master hubs 4M, 9M, 10M, but also a cloud storage 39 and an electromagnetic recordable storage in other external devices (not shown) using the auxiliary communication device 19. For example, for the case of hacking of information passing through the transmission line 27, FIG. 7 (c) shows a connector hub system which is switchable the communication line for all the detected data and the drive programs in the master hub 1M from the normal transmission line 27 to the wireless transmission line 28, and which is manually, automatically or randomly switchable a transmission source from the master hub 1M to another master hub (9M in FIG. 7 (c)).

In the control method according to the present invention shown in FIG. 7, the detected data and the drive program stored in the storage 18 of the one or more hubs are transmitted to the storage 18 of other hubs via the normal transmission line 26 or the wireless transmission line 35 by the auxiliary communication device 19. Specifically, in FIG. 7 (b), all the detected data and the like stored in the storage 18 of the master hub 1M are transmitted to one or more of the master hubs 4M, 9M, 10M and the cloud storage 39 via the wireless transmission line 35 for the backup, on the other hand, in FIG. 7 (c), all the detected data and the like are transferred to the master hub 9M via transmission line 26 to prevent the information from being extracted. Thereby, a storage source for the detected data and the like and the transmission source thereof to the monitoring device 13 are switched from one hub to another hub(s). As a result, even if the hubs having the detected data and the like are partially failed or damaged, the total loss of the detected data and the like can be prevented by the backup in the connector hub system in FIG. 7 (b). In FIG. 7 (c), the storage source and transmission source of detected data and the like are switched (from 1M to 9M) automatically or randomly by for example, a randomization program to change the transmission line toward the monitoring device 13 to a wireless transmission line 28′. The system in FIG. 7 (c) makes it difficult to identify the transmission source from the outside and improves the effect to deter a hacking attack, whereby solving the conventional problem of the one line (series) system.

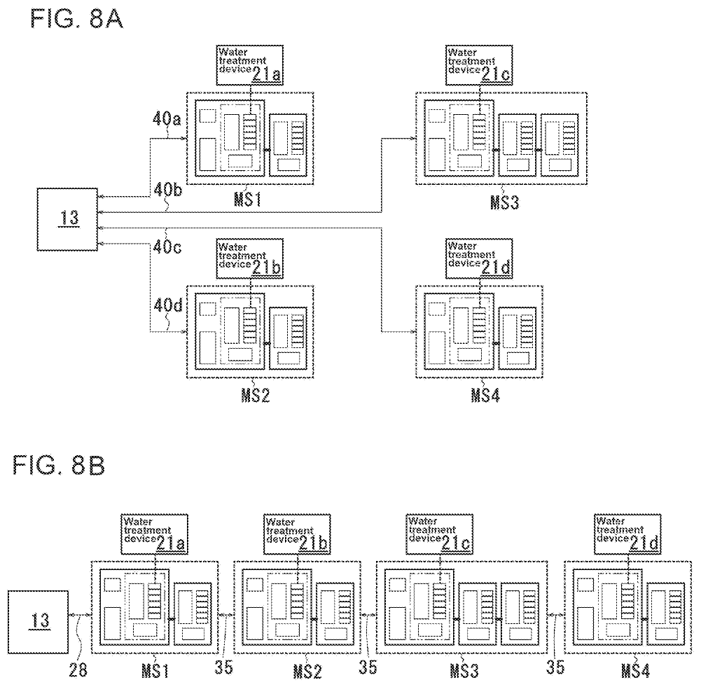

FIG. 8 shows a seventh embodiment of a connector hub system according to the present invention. FIG. 8 (a) shows MS systems MS1-MS4 which are drive-controllably connected to water treatment devices 21a-21d as the controllable drive devices. The water treatment devices 21a-21d include an electric controllable drive device, for example, a motor pump, a valve, a filter, an aerator, an agitator, an ozone generator, a sterilant manufacturing machine, a filter press, a heat exchanger, a control panel, other water treatment facilities. FIG. 8 (a) shows a situation in which the plurality of MS systems MS1-MS4 are connected to the monitoring device 13 via various transmission lines (multi lines) 40a-40d. That is, the monitoring device 13 in FIG. 8 (a) needs to monitor all of the plurality of MS systems MS1-MS4. On the other hand, FIG. 8 (b) shows a connector hub system that the plurality of MS systems MS1-MS4 are connected in series via wireless transmission lines 35 and that the nearest MS system MS1 is directly connected to the monitoring device 13 via the wireless transmission line 28.

The control method according to the present invention shown in FIG. 8 is possible to form one line in series of the plurality of MS systems MS1-MS4 via the wireless transmission lines 35 (FIG. 8 (b)) rather than via separate wireless transmission lines 40a-40d (FIG. 8 (a)) to the monitoring device 13, for controlling the operation of each water treatment device 21a-21d. By forming the one line, the operations of the water treatment devices 21a-21d connected to all the MS systems MS1-MS4 can be monitored by monitoring only the nearest MS system MS1 where all of the detected data are collected, thereby reducing the processing loads on the monitoring device 13.

FIG. 9 shows an eighth embodiment of a connector hub system according to the present invention. The system comprises a series plurality of hubs (three slave hubs 2S,3S,4S in FIG. 9) and three master hubs 1M-1,1M-2,1M-3 directly connected to the nearest hub of the series plurality of hubs via the transmission line 26. The nearest slave hub 2S in FIG. 9 is connected to the three master hubs 1M-1, 1M-2,1M-3 through first, second and third ports 22a,22b,22c of the connector 22 and different transmission lines 26a,26b,26c, and on the other side, is connected to the slave hub 3S through a fourth port 22d of the connector 22 and a transmission line 26. Each of the three master hubs 1M-1,1M-2,1M-3 shares the probes operatively connected to the slave hubs 2S,3S,4S and the detected data obtained from the probes. Each of the three master hubs 1M-1,1M-2,1M-3 is communicated to different destinations 13,43,53 via wireless transmission lines 28,37,38 or wired transmission lines not shown. Conventionally, all of the detected data obtained from the slave hubs 2S,3S,4S were integrated and stored in one cloud storage, and then, each user acquired the detected data from the one cloud storage according to purposes of use. In this case, however, all the detected data could be stolen if the one cloud storage is hacked. Therefore, the system shown in FIG. 9 distributes and stores the detected data processed or unprocessed according to the purpose of use into each of the data memories 81 in the master hubs 1M-1,1M-2,1M-3, and is effective as a security policy because of preventing a harmful influence that all the detected data is extracted from the one cloud storage. In addition, users having the different purposes of use can protect their privacies.

In the control method according to the present invention shown in FIG. 9, the detected data from the series of plurality of hubs 2S,3S,4S is processed or not processed according to the purpose of use, and is stored into each of the data memories 81 in the plurality of master hubs 1M-1,1M-2,1M-3. The detected data stored in the data memory 81 is transmitted to the plurality of different destinations 13,43,53 via the auxiliary communication devices 19. Thereby, the detected data can be transmitted to the destination 13,43,53 having the different purposes of use by different means (for example, by changing the transmission frequency and selecting the necessary information).

Although the first to eighth embodiments mainly illustrate those for storing all the detected data into the whole data memory 81 and the individual data memory 81a and for storing all the drive programs into the whole drive memory 83, together therewith, all the detected data and the drive programs may be stored, accumulated or kept in the monitoring device 13, a cloud storage 39, a PLC 12, or another existing or newly installed storage device inside or outside the connector hub system, via a wired or wireless transmission line or via the terminal 11 connection. Although the above embodiments mainly illustrate the examples for setting by the monitoring device 13 the drive program, threshold value and terminal type, together therewith or independently, they may be set by PLC 12 or another internal or external device via a wired or wireless transmission line or via the terminal 11 connection. Further, although the embodiments of FIGS. 4 to 6, 8 and 9 illustrate the master-slave (MS) system, the master-master (MM) system may be constituted by comprising the master hub and successively one or more dependent master hubs to the master hub. Power source(s) not shown may be connected to or mounted on all the hubs, or connected to only one or more hubs to supply the electric power to the other hubs. Also, an uninterruptible power supply can be connected to or mounted on the hub as a backup means for the power supply.

Further, the present invention may be a control program to function as the connector hub system and the control method for driving the controllable drive device. In this case, processing details for functioning each part are programed in the control program, so that the processing for each part can be implemented on a computer by executing the control program on the computer. For example, the control program is stored in the storage 18 of the controller 15, so that a processing operation based on the control program can be controlled and processed by the processor 16 connected to the storage 18. Further, the control program of the present invention may be executed by the monitoring device 13 or other external devices (not shown) having a storage and a processor. The storage includes a computer-readable storage medium, for example, a magnetic storage device, an optical disk, a magneto-optical storage medium, a semiconductor memory, a USB memory, an SD memory card, or the like.

FIG. 10 (a) shows a calibration system for the sensing device 14 using the connector hub system according to the present invention, and FIG. 10 (b) shows an embodiment that the calibrated sensing devices 14 are applied to the actual controllable drive devices 21a-21c. The connector hub system in FIG. 10 (a) comprises: a calibration hub 0 comprising at least the terminals 11 and the controller 15; and the probes Pr1, Pr2 for the sensing devices 14 connected to two terminals CN1 and CN2 in the calibration hub 0; and illustrates a situation that the probes Pr1, Pr2 are immersed in calibration solutions 71,72. The calibration hub 0 used for a calibration purpose has the same configuration and functions as the hub 1 shown in FIG. 1. The probes Pr1, Pr2 are those for the sensing devices 14 which require the periodic or non-periodic calibration, and the sensing device 14 is a sensor or a measuring instrument for such as, temperature, humidity, hydrogen ion concentration (pH), residual chlorine concentration, conductivity, chromaticity, turbidity, water level, liquid volume, flow rate, flow velocity, amount of power, mass, etc.

In the calibration method for the sensing device 14 using the calibration system in FIG. 10 (a), firstly, the calibration hub 0, the probes Pr1, Pr2, and the calibration solutions 71,72 are prepared, and the probes Pr1, Pr2 are electrically connected to the terminals CN1, CN2 in the calibration hub 0 and immersed into the calibration solutions 71,72 in containers. For example, in the case of pH sensor probe Pr1, the calibration solution 71 is each standard solution of oxalate, phthalate, neutral phosphate, or borate. In the case of conductivity meter probe Pr2, the calibration solution 72 is, for example, a potassium chloride standard solution. Secondly, the power is turned on to the calibration hub 0, and actual values are measured in the state that the probes Pr1, Pr2 are immersed in each standard solution, and the actual measured value is compared with a preliminarily stored reference value in order to assign to each probe Pr1, Pr2, an inherent coefficient based on the difference between the measured value and the reference value. Each coefficient is related to each corresponding probe Pr1, Pr2 and then stored in the storage 18 of the calibration hub 0. FIG. 10 (a) shows two different types of probes Pr1, Pr2, but one or more identical or different types of probes may be connected to the terminals 11. Further, the plurality of the identical typed probes may be sequentially replaced on the terminal CN1 to continuously acquire each coefficient of the probes. The calibration in FIG. 10 (a) can be performed not only at the field where the probes Pr1, Pr2 are actually used, but also at locations other than the field, for example, in a manufacturing factory or a laboratory for the probes Pr1, Pr2 or the like.

FIG. 10 (b) shows an embodiment that the probes Pr1, Pr2 having the acquired coefficients are actually applied to a water treatment system 80. The water treatment system 80 in FIG. 10 (b) comprises: the probes Pr1, Pr2 connected to the input terminals CN1, CN2 in the hub 1; a pH adjustment pump 21a, a bypass valve 21b and a secondary filtration valve 21c as the controllable drive devices respectively connected to the output terminals CN4, CN5, CN6; a primary filter 73 for purifying and treating an untreated water supplied from an inlet pipeline 77; a secondary filter 74 having a conductivity reducing function; and a treated water tank 78 to accumulate water treated by the primary and secondary filters 73,74 via each filtration pipeline 79,89 and to immerse the probes Pr1, Pr2 in the treated water tank 78. Although the configuration of FIG. 10 (b) shows the single hub 1, the single hub 1 also may be connected with the monitoring device 13 and at least one hub 2 via the transmission lines 27,26 (as shown in for example, FIGS. 3 to 9) to configure the monitoring device 13 and hubs 1,2 connected in series. The hub 1 acquires the coefficients for the probes Pr1, Pr2 stored in the calibration hub 0 from the calibration hub 0 mounted on for example, the monitoring device 13 via the transmission line 27, and then, the hub 1 stores the coefficients in the calibration database 84 (FIG. 2).

In FIG. 10 (b), the calibration unit 64 (FIG. 2) calibrates the detected data obtained from the probes Pr1, Pr2 with a calculation by applying the coefficient stored in the calibration database 84, and then, the comparison unit 67 compares the value of the calibrated detected data to the threshold value, and then, the drive command unit 68 transmits a drive signal based on the comparison result to the controllable drive device 21a-21c. For example, the pH detected data obtained from the pH sensor probe Pr1 in the treated water tank 78 through the input terminal CN1 is calculated by the calibration unit 64 (FIG. 2) using the coefficient for the probe Pr1 stored in the calibration database 84 to transmit the drive signal to the pH adjustment pump 21a based on the comparison result between the value of the calibrated detected data and the threshold value. The drive signal includes: a signal to activate the pH adjustment pump 21a for injecting an acid or alkali pH adjustment agent 75 into the inlet pipeline 77; a signal to stop injection; or a signal to determine a rotation speed for a pump motor.

For example, if the probe Pr2 in the treated water tank 78 is the probe for conductivity meter, the detected data of conductivity obtained through the input terminal CN2 is calculated by the calibration unit 64 (FIG. 2) with the coefficient for the probe Pr2 stored in the calibration database 84, and then, based on the comparison result between the threshold value and the calibrated detected data value, the drive signal is transmitted through the output terminals CN5, CN6 and signal lines 76b,76C to the bypass valve 21b and the secondary filtration valve 21c. The drive signal includes a signal to open and shut the bypass valve 21b and/or the secondary filtration valve 21c or a signal to determine an opening degree of each valve 21b,21c.

### INDUSTRIAL APPLICABILITY

The connector hub system, the control method, and the control program of the present invention can be used in the industries for an electronic device, a system, a plant, and an industrial complex, which are controlled using sensor(s).

### REFERENCE SIGNS LIST

1-10 . . . Hub, 11 . . . Terminal, 13 . . . Monitoring device, 14, 24 . . . Sensing device,
15 . . . Controller, 16 . . . Processor, 18 . . . Storage, 19 . . . Auxiliary communication device,
21a-21c . . . Controllable drive device, 23 . . . Repeater, 26 . . . Transmission line,
35 . . . Wireless transmission line, 62 . . . AD conversion unit, 63 . . . Digital receiving unit,
65 . . . Storing unit, 67 . . . Comparison unit, 68 . . . Drive command unit, 81 . . . Data memory
(Whole data memory), 81a . . . Individual data memory, 83 . . . Whole drive memory,
MS . . . Master-slave system.

1. A connector hub system comprising:
a sensing device for detecting a physical quantity, a chemical quantity, a change amount, and/or a condition, of a monitored target;
a hub connected to the sensing device and having terminals to input detected data from the sensing device;
a controller mounted in the hub and containing a processor and a storage;
a data memory in the storage for storing the detected data collected from the sensing device; and
a connector configured on the hub so as to detachably connect between the hub and another hub; wherein
the data memory in the hub is communicatively connected to a monitoring device for monitoring the detected data from the sensing device; and
the monitoring device is connected in series to the plurality of hubs and monitors a nearest hub closest to the monitoring device for observing all of the detected data input to the plurality of hubs.

2. The connector hub system according to claim 1, wherein
the plurality of hubs comprises at least the nearest hub and an end hub connected to the nearest hub; and
the data memory in the nearest hub is a whole data memory which stores all of the detected data collected from the plurality of hubs.

3. The connector hub system according to claim 1, wherein
the monitoring device includes one or more selected from a personal computer, a mobile device, a smartphone, a mobile phone, a tablet, a programmable logic controller, and a dedicated device or board having a monitoring program, and
the monitoring device, via wired or wireless communication, is capable of updating, rewriting, or changing a threshold value and a program stored in the storage of the hub.

4. The connector hub system according to claim 1, wherein
the plurality of hubs comprises at least the nearest hub and an end hub connected to the nearest hub;
the storage in the nearest hub contains a whole drive memory which stores all of drive programs to control controllable drive devices connected to the plurality of hubs; and
the monitoring device is connected to the whole drive memory and monitors all of the drive programs stored in the whole drive memory.

5. The connector hub system according to claim 1,
wherein the processor of the controller comprises:
an AD conversion unit to convert the detected data from an analog signal into a digital signal, the AD conversion unit inputting the detected data as the analog signal from the sensing device through the terminal of the hub;
a digital receiving unit to receive the detected data as the digital signal from the AD conversion unit and from the sensing device through the terminal of the hub;
a storing unit to store the detected data from the digital receiving unit into an individual data memory in the storage;
a comparison unit to compare between a numerical value of the detected data from the digital receiving unit or from the individual data memory and a threshold value stored in a threshold database of the storage; and
a drive command unit, based on a result obtained by the comparison unit, to output a drive signal to a controllable drive device connected to the terminal of the hub.

6. The connector hub system according to claim 5, further comprising a calibration unit to calibrate the detected data by applying a coefficient stored in a calibration database,
wherein the comparison unit compares between the numerical value of the calibrated detected data and the threshold value in the threshold database.

7. The connector hub system according to claim 5, further comprising a data transmission unit to transmit the detected data from the digital receiving unit to an outside of the hub for storing or accumulating the detected data.

8. The connector hub system according to claim 1, wherein
the plurality of hubs comprises:
a master hub with an auxiliary communication device capable of wired or wireless communication to an outside of the master hub; and
a slave hub which is serially dependent from the master hub and has no auxiliary communication device; wherein
the master hub and slave hub constitute a series of master-slave system; and
the processor of the slave hub comprises a data transmission unit to transmit to at least the master hub, the detected data collected from the sensing device.

9. A control method for a connector hub system, comprising steps of:
assigning a terminal type to each of terminals in a hub, the terminal type being any of a digital input, an analog input, a digital output, or an analog output;
detecting by a plurality of sensing devices, a physical quantity, a chemical quantity, a change amount, and/or a condition, of a monitored target;
inputting detected data from the plurality of sensing devices through the terminals assigned with the terminal types;
converting by an AD conversion unit, the detected data from an analog signal into a digital signal, the AD conversion unit inputting the detected data as the analog signal through the terminals of the hub;
receiving by a digital receiving unit, the detected data as the digital signal from the AD conversion unit and from the plurality of sensing devices through the terminals of the hub;
storing by a storing unit, the detected data from the digital receiving unit into an individual data memory of a storage;
comparing by a comparison unit, between a numerical value of the detected data from the digital receiving unit or from the individual data memory and a threshold value stored in a threshold database of the storage; and
based on a result obtained by the comparison unit, outputting by a drive command unit, a drive signal to controllable drive devices connected to the terminals of the hub; wherein
the connector hub system comprises a monitoring device connected in series to a plurality of hubs, and
the monitoring device monitors a nearest hub closest to the monitoring device for observing all of the detected data input to the plurality of hubs.

10. The control method according to claim 9, further comprising a step of transmitting by a data transmission unit, the detected data from the digital receiving unit of one hub to the monitoring device, a cloud storage, a programmable logic controller, and/or another hub, in order to store or accumulate the detected data,
wherein the monitoring device includes one or more selected from a personal computer, a mobile device, a smartphone, a mobile phone, a tablet, the programmable logic controller, and a dedicated device or board having a monitoring program.

11. The control method according to claim 9, further comprising steps of:
making a series connection between at least, a first master-dependent system proximal to the monitoring device and a second master-dependent system distal to the monitoring device;
when a transmission line is interrupted between the monitoring device and the second master-dependent system, wirelessly connecting the second master-dependent system to the monitoring device via an auxiliary communication device in a master hub of the second master-dependent system; and
monitoring a whole data memory and a whole drive memory of the master hub of the second master-dependent system to observe all of the detected data and all of drive programs of the second master-dependent system and all other master-dependent systems distal from the second master-dependent system;
wherein each of the first and second master-dependent systems comprises: the master hub with the auxiliary communication device capable of communicating to an outside of the first and second master-dependent systems; and a dependent hub which is serially dependent from the master hub.

12. The control method according to claim 9, further comprising steps of:
forming a plurality of master-dependent systems which comprises: a master hub with an auxiliary communication device capable of communicating to an outside of the master hub; and a dependent hub which is serially dependent from the master hub; the master hub and the dependent hub being connected in series to the monitoring device;
when a wired connection is not made between a first master-dependent system and another master-dependent system, wirelessly connecting the auxiliary communication device of a nearest wired-disconnected master-dependent system to the first master-dependent system directly connected to the monitoring device;
transmitting from the nearest wired-disconnected master-dependent system to the master hub of the first master-dependent system, all of the detected data and all of drive programs of the nearest wired-disconnected master-dependent system and all other master-dependent systems distal from the nearest wired-disconnected master-dependent system; and
storing all of the detected data and all of the drive programs into a whole data memory and a whole drive memory of the master hub of the first master-dependent system.

13. The control method according to claim 9, further comprising steps of:
transmitting the detected data and a drive program stored in the storage of one hub to another hub via a normal transmission line or via an auxiliary communication device and a wireless transmission line;
storing the detected data and the drive program into the storage of the another hub to change a source of the detected data from the one hub to the another hub.

14. The control method according to claim 9, further comprising steps of:
controlling each of the controllable drive devices by a plurality of master-dependent systems wirelessly connected to the monitoring device via different transmission lines;
wirelessly connecting the plurality of master-dependent systems in series to each other to form a one line;
monitoring only a master-dependent system nearest to the monitoring device in order to observe all operations of the controllable drive devices connected to the master-dependent systems.

15. The control method according to claim 9, further comprising a step of transmitting the detected data from a series of the plurality of hubs to different destinations via auxiliary communication devices of a plurality of master hubs.

16. The control method according to claim 9, further comprising steps of:
measuring an actual value of a standard solution by a probe for the sensing device connected to a calibration hub, comparing the actual value to a reference value previously stored in the storage, and based on a difference between the actual value and the reference value, assigning a coefficient inherent in the probe thereto;
relating the coefficient to the probe and storing the coefficient assigned and related to the probe into the storage of the calibration hub;
connecting the probe assigned with the coefficient to the hub applied to an actual system;
storing the coefficient stored in the calibration hub via a transmission line into a calibration database of the hub applied to the actual system;
calibrating by a calculation of a calibration unit, the detected data obtained from the probe by applying the coefficient stored in the calibration database; and
comparing by a comparison unit, between the numerical value of the detected data calibrated by the calibration unit and a threshold value.

17. A control program product comprising
a storage media for causing a computer to execute the control method according to claim 9.
